(19) United States
(12) Patent Application Publication
(10) Pub. No.: US 2026/0005284 A1
(43) Pub. Date: Jan. 1, 2026

(54) BATTERY CELL WITH LAMINATED REFERENCE ELECTRODE CORE AND Z-FOLDING STACK

(71) Applicant: GM GLOBAL TECHNOLOGY OPERATIONS LLC, Detroit, MI (US)

(72) Inventors: Taylor Reed GARRICK, Bloomfield Hills, MI (US); Brian J. KOCH, Berkley, MI (US)

(21) Appl. No.: 18/754,518

(22) Filed: Jun. 26, 2024

(51) Int. Cl. H01M 10/04; H01M 4/36; H01M 4/58; H01M 50/103; H01M 50/176; H01M 50/538; H01M 50/552

(52) U.S. Cl. CPC H01M 10/0431; H01M 4/366; H01M 4/5825; H01M 50/103; H01M 50/176; H01M 50/538; H01M 50/552

(57) ABSTRACT

A battery cell includes a Z-folded separator, C cathode electrodes arranged on one side of the Z-folded separator, and A anode electrodes arranged on the other side of the Z-folded separator, where A and C are integers greater than one. A reference core includes a first separator, a first anode electrode arranged adjacent to the first separator, a second separator arranged adjacent to the first anode electrode, a reference electrode arranged adjacent to the second separator, a third separator arranged adjacent to the reference electrode, a first cathode electrode arranged adjacent to the third separator, and a fourth separator. The reference core is arranged in the Z-folded separator between inner sides of a second cathode electrode and a second anode electrode. Outer sides of the second cathode electrode and the second anode electrode are arranged adjacent to the same side of the Z-folded separator.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a battery cell with a laminated reference electrode core and Z-folding stack.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

### SUMMARY

A battery cell includes a Z-folded separator, C cathode electrodes arranged on one side of the Z-folded separator, and A anode electrodes arranged on the other side of the Z-folded separator, where A and C are integers greater than one. A reference core includes a first separator, a first anode electrode arranged adjacent to the first separator, a second separator arranged adjacent to the first anode electrode, a reference electrode arranged adjacent to the second separator, a third separator arranged adjacent to the reference electrode, a first cathode electrode arranged adjacent to the third separator, and a fourth separator. The reference core is arranged in the Z-folded separator between inner sides of a second cathode electrode and a second anode electrode. Outer sides of the second cathode electrode and the second anode electrode are arranged adjacent to the same side of the Z-folded separator.

In other features, the reference electrode includes a conductive layer and an active material layer. A length and width of the reference core is greater than or equal to a width of active material layers of the C cathode electrodes and the A anode electrodes.

In other features, first external tabs connected to the C cathode electrodes, second external tabs connected to the A anode electrodes, and a third external tab connected to the conductive layer of the reference electrode. The conductive layer is made of gold. The active material layer comprises lithium iron phosphate.

In other features, an enclosure includes a lid portion, a cathode terminal arranged on the lid portion and connected by a first conductor to the first external tabs, an anode terminal arranged on the lid portion and connected by a second conductor to the second external tabs, and a reference electrode terminal arranged on the lid portion and connected by a third conductor to the third external tab.

In other features, an enclosure includes a lid portion, a cathode terminal arranged on the lid portion and connected by a first conductor to the first external tabs, an anode terminal arranged on the lid portion and connected by a second conductor to the second external tabs, a fill opening is arranged on the lid portion, and a reference electrode terminal is arranged in the fill opening.

In other features, an enclosure includes a lid portion. A cathode terminal is arranged on the lid portion and connected by a first conductor to the first external tabs. An anode terminal is arranged on the lid portion and connected by a second conductor to the second external tabs. A vent cap arranged in a vent opening in the lid portion. A reference electrode terminal is arranged on the vent cap.

In other features, the battery cell is arranged in a prismatic enclosure. The first separator, the first anode electrode, and the second separator are laminated to one side of the reference electrode, and the third separator, the first cathode electrode, and the fourth separator are laminated to the other side of the reference electrode.

A laminated reference core for a battery cell includes a first separator, a first anode electrode arranged adjacent to the first separator, a second separator arranged adjacent to the first anode electrode, a reference electrode arranged adjacent to the second separator, a third separator arranged adjacent to the reference electrode, a first cathode electrode arranged adjacent to the third separator, and a fourth separator arranged adjacent to the first cathode electrode. The first separator, the first anode electrode, the second separator, the reference electrode, the third separator, the first cathode electrode, and the fourth separator are laminated.

In other features, the reference electrode includes a conductive layer and an active material layer. The conductive layer is made of gold. The active material layer comprises lithium iron phosphate.

A battery cell includes a Z-folded separator, C cathode electrodes arranged on one side of the Z-folded separator, A anode electrodes arranged on the other side of the Z-folded separator, where A and C are integers greater than one. The laminated reference core is arranged in the Z-folded separator between inner sides of the second cathode electrode and the second anode electrode. Outer sides of the second cathode electrode and the second anode electrode are arranged adjacent to the same side of the Z-folded separator.

In other features, the second cathode electrode and the second anode electrode are arranged adjacent to the same side of the Z-folded separator. The laminated reference core has a length and width greater than the A anode electrodes.

A battery cell includes S separators, C cathode electrodes, and A anode electrodes, where S, A, and C are integers greater than one. The laminated reference core is arranged in a stack including the S separators, the C cathode electrodes, and the A anode electrodes. The laminated reference core has a length and width greater than the A anode electrodes.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a side cross section of an example of a battery cell including C cathode electrodes, A anode electrodes, and S separators;

FIG. 1B is a perspective view of an example of a prismatic battery cell;

FIGS. 2A and 2B are side cross sections of examples of a cathode electrode and an anode electrode, respectively;

FIG. 3A side cross section of an example of a battery cell including cathode electrodes, anode electrodes, a Z-folded separator, and a laminate reference core including a reference electrode according to the present disclosure;

FIG. 3B side cross section of an example of a battery cell including cathode electrodes, anode electrodes, separators, and a laminate reference core including a reference electrode according to the present disclosure;

FIG. 4 is a side cross section of an example of the battery cell according to the present disclosure;

FIG. 5 is a plan view of an example of a lid portion of the battery cell according to the present disclosure;

FIG. 6 is a side cross section of another example of the battery cell according to the present disclosure;

FIGS. 7 and 8 are plan views of other examples of lid portions of the battery cell according to the present disclosure; and

FIG. 9 is a flowchart for a method for manufacturing a battery cell according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Battery cells according to the present disclosure incorporate a reference electrode into a prismatic battery cell. The reference electrode is laminated between a first set of separators, an anode and cathode pair, and second set of separators. The laminated structure is incorporated into a Z-folding stack architecture (or standard batter cell stack with separate separators) including other anode and cathode electrodes. Due to the added strength of the additional layers, the laminated structure is stronger and can be handled more easily during manufacturing (as compared to handling a reference electrode by itself).

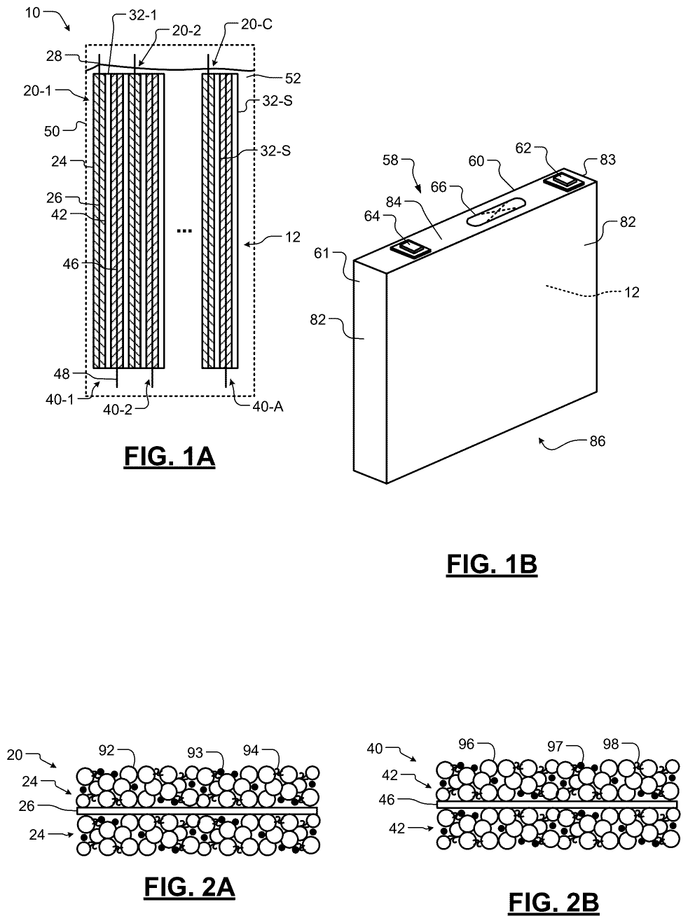

Referring now to FIG. 1A, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. Liquid electrolyte 52 is added to the enclosure 50.

The C cathode electrodes 20-1, 20-2, . . . , and 20-C include a cathode active material layer 24 arranged on one or both sides of a cathode current collector 26. The A anode electrodes 40-1, 40-2, . . . , and 40-A include anode active material layers 42 arranged on one or both sides of the anode current collectors 46. The S separators 32-1, 32-2, . . . , and 32-S are arranged between the C cathode electrodes 20 and the A anode electrodes 40.

In some examples, the A anode electrodes 40 and the C cathode electrodes 20 exchange lithium ions during charging/discharging. In some examples, the cathode active material layers 24 and/or the anode active material layers 42 comprise coatings including one or more active materials, one or more optional conductive additives, and/or one or more optional binder materials that are cast or applied onto one or both sides of the current collectors 26 and/or 46, respectively.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to cathode and anode terminals of the battery cells. respectively.

Referring now to FIG. 1B, a battery cell 58 includes an enclosure 60. In some examples, the enclosure 60 has a prismatic shape with rectangular cross-sections in x-, y- and z-axis planes. In some examples, the enclosure 60 includes an enclosure body 61 including sides 80 corresponding to narrow faces and sides 82 corresponding to wide faces. The enclosure body 61 defines an open-ended rectangular prism. In some examples, the enclosure 60 includes a lid portion 84 and a bottom portion 86. In other examples, the bottom portion 86 is attached after the enclosure 60 is formed.

The lid portion 84 and optionally the bottom portion 86 are attached to the enclosure body 61 to enclose top and the bottom openings of the enclosure body 61, respectively. The battery cell 58 includes external terminals 62 and 64 that pass through the lid portion 84. The battery cell stack 12 of the C cathode electrodes 20, the A anode electrodes 40, and the S separators 32 is arranged in the enclosure 60.

The external terminals 62 and 64 are connected to external tabs 28 and 48 of the C cathode electrodes 20 and the A anode electrodes 40, respectively. The lid portion 84 (and/or the bottom portion 86) includes a pressure-based vent cap 66. The pressure-based vent cap 66 is configured to release vent gases when pressure within the inner enclosure is greater than a predetermined pressure.

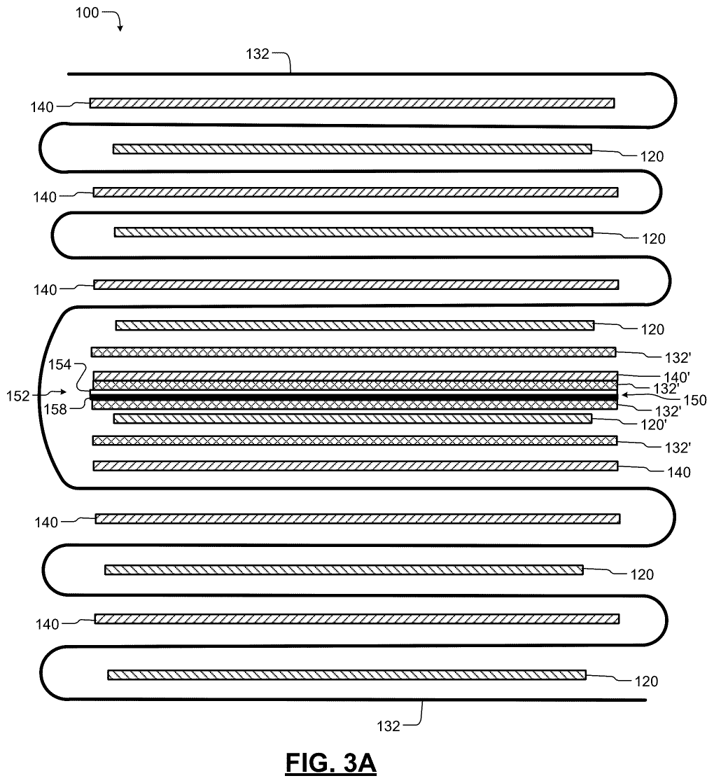

Referring now to FIGS. 2A and 2B, examples of the electrodes are shown. In FIG. 2A, one of the C cathode electrodes 20 is shown in more detail. The cathode active material layer 24 includes a cathode active material 92, an optional conductive additive 93, and an optional binder 94. In FIG. 2B, one of the A anode electrodes 40 is shown in more detail. The anode active material layer 42 includes an anode active material 96, an optional conductive additive 97, and an optional binder 98.

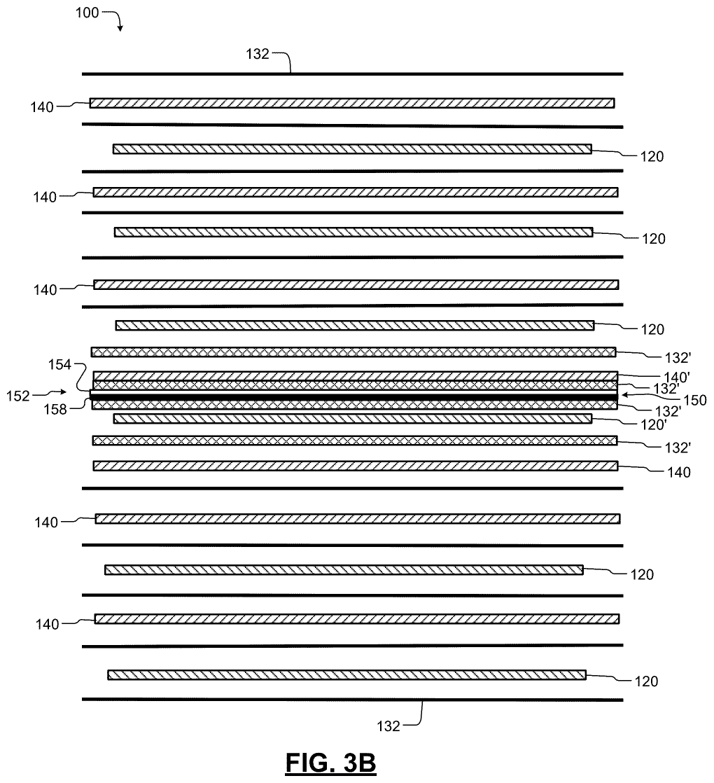

Referring now to FIGS. 3A and 3B, a battery cell 100 according to the present disclosure is shown. In FIG. 3A, the battery cell 100 includes cathode electrodes 120, anode electrodes 140, and a Z-folding separator 132 interleaved between the cathode electrodes 120 and the anode electrodes 140. In some examples, the cathode electrodes 120 and the anode electrodes 140 are arranged on opposite sides of the Z-folding separator 132.

A laminate reference core 150 includes a reference electrode 152, a first pair of separators 132′ arranged on opposite sides thereof, a cathode electrode 120′, an anode electrode 140′, and a second pair of separators 132′ arranged on outer surfaces of the cathode electrode 120′ and the anode electrode 140′. The reference electrode 152 includes a conductive layer 154 and an active material layer 158. In some examples, the conductive layer 154 includes a gold layer, although other materials can be used. In some examples, the active material layer 158 includes a lithium iron phosphate (LFP) layer, although other lithium-containing materials can be used.

The laminate reference core 150 is arranged between another cathode electrode 120 and another anode electrode 140 in one of the Z-folds (located on the same side of the Z-folding separator 132). In some examples, the laminate reference core 150 has a predetermined thickness. In some examples, the Z-folded separator 132 is lengthened (by the predetermined thickness of the laminate reference core 150) in the one of the Z-fold bends to accommodate the additional thickness of the laminate reference core 150. In FIG. 3B, the Z-folding separator 132 is replaced by individual separators 132′. In some examples, the one of the Z-fold bends is in the middle of the battery stack.

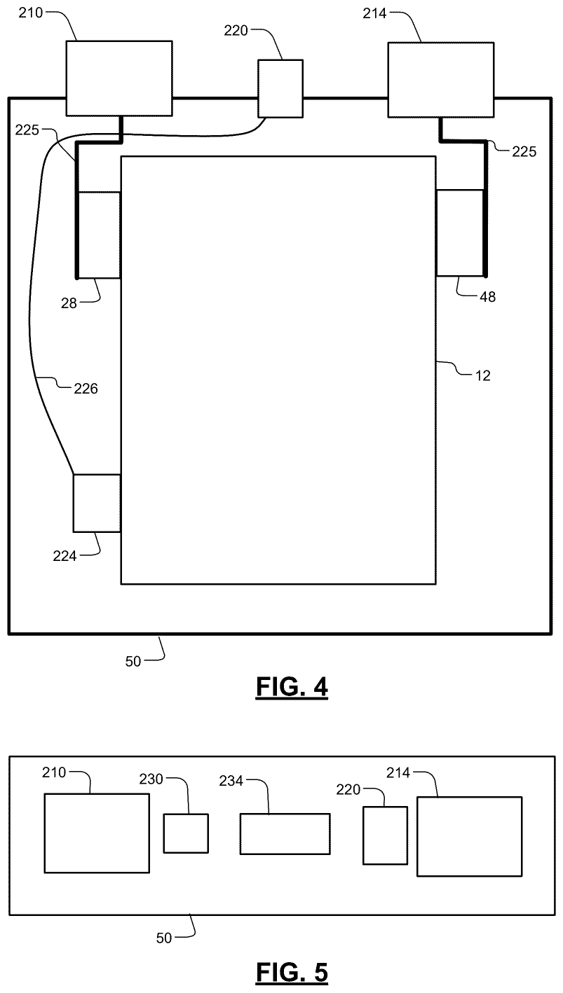

Referring now to FIGS. 4 and 5, the stack 12 is arranged in the enclosure 50. The external tabs 28 and 48 of the cathode electrodes 120 and anode electrodes 140 are connected by conductors 225 to cathode and anode terminals 210 and 214 of the battery cell, respectively. An external tab 224 for the reference electrode 152 extends from one of the sides and is connected by a conductor 226 to a reference electrode terminal 220. The external tab 224 is isolated from the enclosure. In some examples, a fill opening/plug 230 and a vent opening/cap 234 are arranged between the cathode and anode terminals 210 and 214 as shown in FIG. 5.

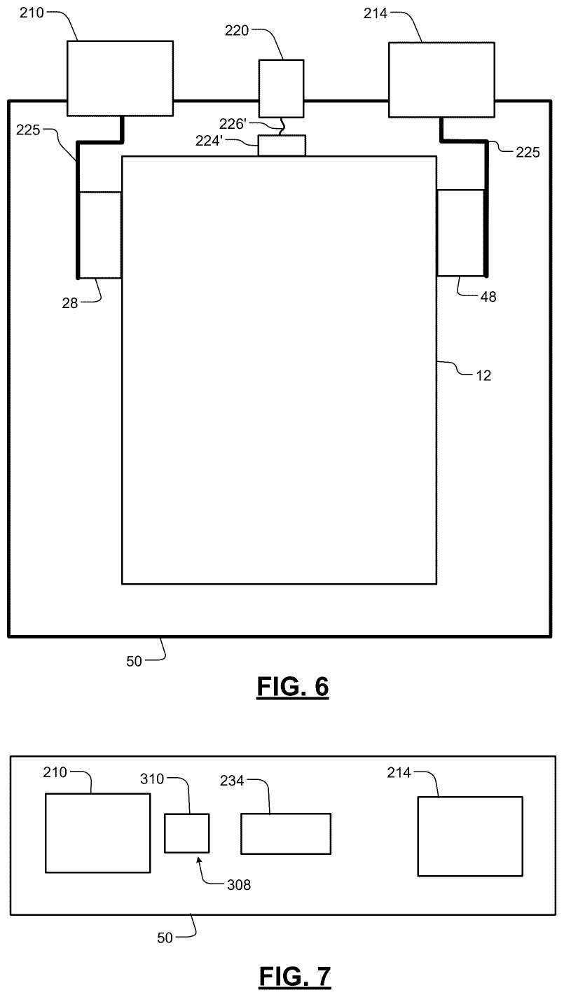

Referring now to FIG. 6, in some examples, the external tab 224′ and the conductor 226′ for the reference electrode 152 are arranged on a top side of the stack 12 (adjacent to the lid portion when located in the enclosure 50) and the external tabs 28 and 48 are located on opposite sides of the stack 12.

Referring now to FIG. 7, in some examples, a fill opening 308 can be used for mounting a reference electrode terminal 310. After filling the enclosure with electrolyte, the fill opening 308 is no longer needed for that purpose. The reference electrode terminal 310 is mounted in the fill opening to block the fill opening 308 and the conductor 226 for the reference electrode terminal 310 is routed/connected to the reference electrode terminal 310.

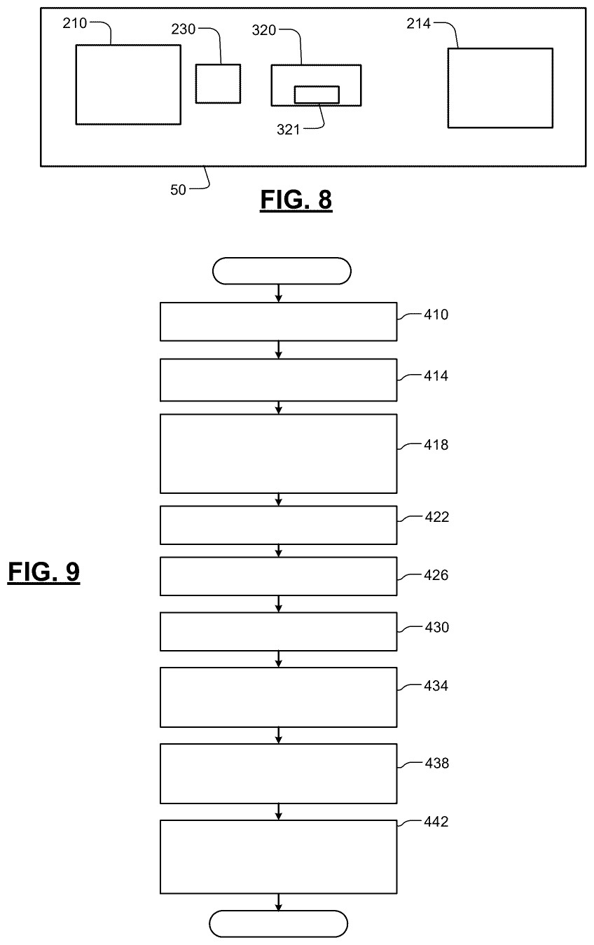

Referring now to FIG. 8, in some examples, a vent cap 320 is used for mounting a reference electrode terminal 321. In other words, the reference electrode terminal 321 is integrated with the vent cap 320.

In some examples, the reference electrode has dimensions greater than or equal to a full coating area of the anode material layer. Lamination of a separator mounted reference electrode with an anode and cathode electrode pair and outer separator pair facilitates uniform contact to the reference electrode while improving ease of manufacturing.

In some examples, the laminated structure is mounted at or near the center of the Z-folded stack. In some examples, the conductor connected to the reference electrode is located on the cathode side. In some examples, the reference electrode has the same or higher porosity as the separator to not restrict electrolyte salt flux during operation.

Referring now to FIG. 9, a method for manufacturing a battery cell is shown. At 410, a reference electrode arranged between separators is provided or laminated. In some examples, the reference electrode includes a conductive layer such as gold and an active material layer including lithium iron phosphate with porosity that is the same as or higher than the separator.

At 414, the separator mounted reference electrode is optionally cut to a predetermined size. In some examples, the predetermined size is greater than size (e.g., length and width) of the anode electrode by a predetermined tolerance.

A separator, an anode electrode, the separator mounted reference electrode, a cathode electrode, and another separator are stacked at 418 and laminated at 422 to form a laminated reference core. In some examples, heat, pressure, and/or a conductive adhesive is used between one or more adjacent layers.

At 426, the laminated reference core is inserted into a Z-folding assembly including other cathode electrodes and anode electrodes. In some examples, the laminated reference core is inserted into a middle of the Z-folding assembly. At 430, one or more of the Z-folding assemblies are inserted into a battery enclosure (e.g., a prismatic enclosure).

At 434, the cathode tabs of the one or more Z-folding assemblies are welded to a cathode weld plate and the cathode weld plate is welded to the cathode terminal. At 438, the anode tabs of the one or more Z-folding assemblies are welded to an anode weld plate and the anode weld plate is welded to the anode terminal. At 442, the reference electrode tabs of the one or more Z-folding assemblies are welded to reference electrode lead and the reference electrode lead is welded to the reference electrode.

In some examples, the reference electrode terminal is located adjacent to the anode terminal or the cathode terminal in the lid portion to minimize the potential difference between adjacent terminals.

Using the reference electrode allows diagnostics to separately measure anode and cathode potentials during operation. The reference electrode enables improved diagnostics enabling better control during fast charging. The reference electrode also enables improved failure sensing.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery cell, comprising:
a Z-folded separator;
C cathode electrodes arranged on one side of the Z-folded separator;
A anode electrodes arranged on the other side of the Z-folded separator, where A and C are integers greater than one; and
a reference core including:
a first separator;
a first anode electrode arranged adjacent to the first separator;
a second separator arranged adjacent to the first anode electrode;
a reference electrode arranged adjacent to the second separator;
a third separator arranged adjacent to the reference electrode;
a first cathode electrode arranged adjacent to the third separator; and
a fourth separator;
a second cathode electrode; and
a second anode electrode,
wherein the reference core is arranged in the Z-folded separator between inner sides of the second cathode electrode and the second anode electrode, and
wherein outer sides of the second cathode electrode and the second anode electrode are arranged adjacent to the same side of the Z-folded separator.

2. The battery cell of claim 1, wherein the reference electrode includes a conductive layer and an active material layer.

3. The battery cell of claim 1, wherein a length and width of the reference core is greater than or equal to a width of active material layers of the C cathode electrodes and the A anode electrodes.

4. The battery cell of claim 2, further comprising:
first external tabs connected to the C cathode electrodes;
second external tabs connected to the A anode electrodes; and
a third external tab connected to the conductive layer of the reference electrode.

5. The battery cell of claim 2, wherein the conductive layer is made of gold.

6. The battery cell of claim 2, wherein the active material layer comprises lithium iron phosphate.

7. The battery cell of claim 4, further comprising:
an enclosure including a lid portion;
a cathode terminal arranged on the lid portion and connected by a first conductor to the first external tabs;
an anode terminal arranged on the lid portion and connected by a second conductor to the second external tabs; and
a reference electrode terminal arranged on the lid portion and connected by a third conductor to the third external tab.

8. The battery cell of claim 4, further comprising:
an enclosure including a lid portion;
a cathode terminal arranged on the lid portion and connected by a first conductor to the first external tabs;
an anode terminal arranged on the lid portion and connected by a second conductor to the second external tabs;
a fill opening arranged on the lid portion; and
a reference electrode terminal arranged in the fill opening.

9. The battery cell of claim 4, further comprising:
an enclosure including a lid portion;
a cathode terminal arranged on the lid portion and connected by a first conductor to the first external tabs;
an anode terminal arranged on the lid portion and connected by a second conductor to the second external tabs;
a vent cap arranged in a vent opening in the lid portion; and
a reference electrode terminal arranged on the vent cap.

10. The battery cell of claim 1, wherein the battery cell is arranged in a prismatic enclosure.

11. The battery cell of claim 1, wherein:
the first separator, the first anode electrode, and the second separator are laminated to one side of the reference electrode, and
the third separator, the first cathode electrode, and the fourth separator are laminated to the other side of the reference electrode.

12. A laminated reference core for a battery cell, comprising
a first separator;
a first anode electrode arranged adjacent to the first separator;
a second separator arranged adjacent to the first anode electrode;
a reference electrode arranged adjacent to the second separator;
a third separator arranged adjacent to the reference electrode;
a first cathode electrode arranged adjacent to the third separator; and
a fourth separator arranged adjacent to the first cathode electrode,
wherein the first separator, the first anode electrode, the second separator, the reference electrode, the third separator, the first cathode electrode, and the fourth separator are laminated.

13. The laminated reference core of claim 12, wherein the reference electrode includes a conductive layer and an active material layer.

14. The laminated reference core of claim 13, wherein the conductive layer is made of gold.

15. The laminated reference core of claim 13, wherein the active material layer comprises lithium iron phosphate.

16. A battery cell comprising:
a Z-folded separator;
C cathode electrodes arranged on one side of the Z-folded separator;
A anode electrodes arranged on the other side of the Z-folded separator, where A and C are integers greater than one;
a second cathode electrode; and
a second anode electrode,
wherein the laminated reference core of claim 12 is arranged in the Z-folded separator between inner sides of the second cathode electrode and the second anode electrode, and
wherein outer sides of the second cathode electrode and the second anode electrode are arranged adjacent to the same side of the Z-folded separator.

17. The battery cell of claim 16, wherein the second cathode electrode and the second anode electrode are arranged adjacent to the same side of the Z-folded separator.

18. The battery cell of claim 16, wherein the laminated reference core has a length and width greater than the A anode electrodes.

19. A battery cell comprising:
S separators;
C cathode electrodes; and
A anode electrodes, where S, A, and C are integers greater than one,
wherein the laminated reference core of claim 16 is arranged in a stack including the S separators, the C cathode electrodes, and the A anode electrodes.

20. The battery cell of claim 19, wherein the laminated reference core has a length and width greater than the A anode electrodes.
